(19) United States
(12) Patent Application Publication
(10) Pub. No.: US 2020/0364906 A1
(43) Pub. Date: Nov. 19, 2020

(54) Image Inspection Apparatus

(71) Applicant: Keyence Corporation, Osaka (JP)

(72) Inventor: Masato SHIMODAIRA, Osaka (JP)

(73) Assignee: Keyence Corporation, Osaka (JP)

(21) Appl. No.: 16/839,189

(22) Filed: Apr. 3, 2020

(30) Foreign Application Priority Data
May 16, 2019 (JP) 2019-093174

(51) Int. Cl. G06T 9/00; G06N 3/02; G06T 7/00; G01N 21/88

(52) U.S. Cl. CPC G06T 9/002; G01N 21/88; G06T 7/00; G06N 3/02

(57) ABSTRACT

It is possible to apply normal inspection processing and deep learning processing, and it is possible to achieve both the rapidity of inspection processing and a high ability to cope with a complicated discrimination. A defect candidate portion is extracted based on a pixel value of an input inspection target image. An inspection window is set in a region including the extracted defect candidate portion. An image within the inspection window is input to the classifier, and thus, it is determined whether the inspection target image is classified into a first class or a second class.

### CROSS-REFERENCE TO RELATED APPLICATIONS

The present application claims foreign priority based on Japanese Patent Application No. 2019-093174, filed May 16, 2019, the contents of which are incorporated herein by reference.

### BACKGROUND OF THE INVENTION

### 1. Field of the Invention

The present invention relates to an image inspection apparatus capable of performing classification of an inspection target based on an image obtained by capturing the inspection target.

### 2. Description of Related Art

For example, as disclosed in JP 2013-120550 A, in general inspection processing using an image obtained by capturing an inspection target, a quality determination of the inspection target is performed based on various characteristic amounts (color, edge, or position) of the inspection target within the image (hereinafter, referred to as a normal inspection). In the normal inspection, the quality determination of the inspection target is performed by selecting a characteristic amount to be used for an inspection by a user at the time of setting the image inspection apparatus, setting a threshold as a criterion of the quality determination for the selected characteristic amount, extracting the selected characteristic amount at the time of setting from a newly input inspection image at the time of running, and comparing the extracted characteristic amount with the threshold. It is easy to perform the quality determination for an image with a clear characteristic amount such as a color and an edge. However, for example, the characteristic amount is easily changed by an imaging condition on an inspection target with many color unevenness or an inspection target such as a metal component of which an appearance of an edge is easily changed by a surrounding environment. Even though the quality determination is easily performed by an inspection with the eyes of a person, it may be difficult to perform the determination in the image inspection apparatus, and a determination result may not be stable.

As the inspection processing capable of coping with such a difficult inspection, a deep learning processing technology for causing a known machine learning device such as a neural network to learn characteristics of a non-defective product image obtained by capturing a non-defective product and a defective product image obtained by capturing a defective product and discriminating whether a newly input inspection target image is the non-defective product or the defective product by the machine learning device has been known (for example, see JP 2018-5640 A).

That is, in the case of the normal inspection processing, there is an advantage that a processing load is low and an algorithm is clear, but it is difficult to perform a complicated determination. Meanwhile, in the case of the deep learning processing, the processing load is higher than that of the normal inspection processing, but there is an advantage that an ability to cope with the complicated determination is high.

A defect desired to be detected by an appearance inspection for inspecting an appearance of the inspection target includes, for example, “dent”, “crack”, “chip”, “foreign substance”, and “dirt”. As the existing image processing for detecting these defects includes “flaw detection” and “blob detection”. The flaw detection processing is processing for detecting, as an abnormal portion, a portion at which a predetermined difference or more from the surroundings is generated based on a segmented average density value, and the blob detection is processing for detecting, as a lump, a portion at which the density value is equal to or smaller than a predetermined value, is equal to or larger than the predetermined value, is within a predetermined range, or is out of the predetermined range by binarization based on the density value.

In any processing, it is possible to distinguish between the defects in a case where a difference between the density values of the defect that the user wants to detect and the defect that the user does not want to detect is large or there is a difference in shape characteristics, but there is a problem that it is difficult to distinguish between the defects in other cases. For example, when “dirt” is allowable but “foreign substance” such as insects is not allowable, it is difficult to distinguish “dirt” from “foreign substance” only by a shape characteristic amount of the related art.

Meanwhile, in the deep learning processing, it is possible to classify such a complicated characteristic difference by appropriately performing learning, but it is difficult to perform the classification by using only a small characteristic of a part of the entire inspection target. Thus, a method called a “sliding window method” of repeatedly applying the deep learning processing in a small region having a predetermined size while being shifted at regular intervals is generally performed. In this processing, since the deep learning processing is repeatedly performed while sliding the window, there is a problem that the processing load is higher than that of the existing image processing.

### SUMMARY OF THE INVENTION

The present invention has been made in view of such problems, and an object of the present invention is to apply normal inspection processing and deep learning processing and to achieve both the rapidity of inspection processing and a high ability to cope with a complicated discrimination.

In order to achieve the object, in the present invention, a candidate portion at which a defect may be present is extracted at high speed by normal inspection processing, and an ability to cope with a complicated determination is increased by applying deep learning processing having a high processing load to only the extracted candidate portion.

According to one embodiment of the invention, there is provided an image inspection apparatus that inspects inspection targets based on inspection target images acquired by capturing the inspection targets. The apparatus includes a classifier generation section that generates a classifier which classifies the inspection target images into a first class and a second class by inputting a plurality of learning images including the inspection target image into an input layer of a neural network and causing the neural network to learn in a setting mode, an image input section that inputs the inspection target image in a running mode, a defect candidate extraction section that extracts a defect candidate portion which becomes a defect based on a pixel value of the inspection target image input by the image input section, an inspection window setting section that sets an inspection window in a region including the extracted defect candidate portion, and a determination section that determines whether the inspection target image is classified into the first class or the second class by inputting an image within the inspection window set by the inspection window setting section to the classifier generated by the classifier generation section.

According to this configuration, in the setting mode in which various settings of the image inspection apparatus are performed, the classifier that classifies the inspection target images into the first class and the second class is generated by inputting the plurality of images including the inspection target to the input layer of the neural network. In the running mode of the image inspection apparatus, when the inspection target image acquired by capturing the inspection target is input to the defect candidate extraction section, the defect candidate portion is extracted based on the pixel value of the inspection target image. When the defect candidate portion is extracted, for example, the portion at which the predetermined difference or more from the surroundings is generated may be set as the defect candidate portion based on the segmented average density value, or the portion at which the density value is equal to or smaller than the predetermined value, is equal to or larger than the predetermined value, is within the predetermined range, or is out of the predetermined range may be set as the defect candidate portion by binarization based on the density value. Since these methods are all the general normal inspection processing, the high-speed processing can be performed.

When the defect candidate portion is extracted, since the inspection window is set in the region including the defect candidate portion and the image within the inspection window is input to the classifier, the deep learning processing is performed only on a part of the inspection target image. Therefore, the rapidity of the inspection processing is ensured. Since it is determined whether the inspection target image is classified into the first class or the second class based on the output result of the classifier, it is possible to cope with a complicated determination. The inspection window may be set automatically or may be set by the user.

According to another embodiment of the invention, the first class is a non-defective product image class into which a non-defective product image is classified. The second class is a defective product image class into which a defective product image is classified. The classifier generation section is configured to generate a classifier which classifies the inspection target images into the non-defective product image class and the defective product image class by inputting, as the learning image, a plurality of non-defective product images to which non-defective product attributes are given and/or a plurality of defective product images to which defective product attributes are given to the input layer of the neural network and causing the neural network to learn in the setting mode.

According to this configuration, the classifier that classifies the inspection target image into the non-defective product image class and the defective product image class is generated by the classifier generating section. When the image within the inspection window is input to the classifier, since it is determined whether the inspection target image is classified into the non-defective product image class or the defective product image class, it is possible to perform the quality determination of the inspection target image while maintaining the rapidity.

According to still another embodiment of the invention, the first class is a first defect class into which an image including a first defect is classified. The second class is a second defect class into which an image including a second defect is classified. The classifier generation section is configured to generate a classifier which classifies the inspection target images into the first defect class and the second defect class by inputting, as the learning image, a plurality of images including the first defect and a plurality of images including the second defect to the input layer of the neural network and causing the neural network to learn in the setting mode.

According to this configuration, the classifier that classifies the inspection target image into the first defect class and the second defect class is generated by the classifier generating section. The defect includes, for example, “dent”, “crack”, “chip”, “foreign substance”, and “dirt”. Only one type of defect may be classified or a plurality of types of defects may be classified into the first defect class. Similarly, only one type of defect may be classified or a plurality of types of defects may be classified into the second defect class. Since these defects can be extracted by the normal inspection processing, high-speed processing can be performed.

When the region of the inspection target image including the defect candidate portion is input to the classifier, since it is determined whether the inspection target image is classified into the first defect class or the second defect class, it is possible to perform the classification using the type of the defect while maintaining the rapidity. A classifier that can classify the inspection target images into a third defect class and a fourth defect class may be generated, and the number of classes is not particularly limited. A dent class into which “dent” is classified, a crack class into which “crack” is classified, a chip class into which “chip” is classified, a foreign substance class into which “foreign substance” is classified, and a dirt class into which “dirt” is classified can be provided, and the inspection target images can be classified into the classes by the classifier.

According to still another embodiment of the invention, the first defect includes a plurality of types of defects.

According to this configuration, for example, even when there are three or more types of defects, the inspection target images can be classified into two of the first defect class and the second defect class. The number of classes is not limited to two, but may be three or more.

According to still another embodiment of the invention, the classifier generation section is configured to input, as the learning image, a plurality of images including a defect into the input layer of the neural network and cause the neural network to learn in the setting mode.

According to this configuration, the classification accuracy of the defects using the classifier can be improved.

According to still another embodiment of the invention, the classifier generation section is configured to input a region of the learning image including the defect to the input layer of the neural network and cause the neural network to learn in the setting mode.

According to this configuration, the efficiency of the learning using the neural network can be increased.

According to still another embodiment of the invention, the classifier generation section is configured to perform normalization processing on an image size to be input to the input layer of the neural network in the setting mode.

According to still another embodiment of the invention, the classifier generation section sets an enlargement ratio at the time of performing the normalization processing to be equal to or smaller than a predetermined value.

That is, when the normalization processing is performed by enlarging the image, in a case where the enlargement ratio of the image becomes too high, a noise component included in the image is increased, and becomes a cause of an erroneous determination. Accordingly, the enlargement ratio at the time of performing the normalization processing is set to be equal to or smaller than a predetermined value, and thus, it is difficult to cause the erroneous determination by suppressing an increase in the noise component.

According to still another embodiment of the invention, the defect candidate extraction section is configured to perform flaw detection processing for extracting, as a defect candidate portion, a portion at which a predetermined difference or more from surroundings is generated based on a segmented average density value.

According to still another embodiment of the invention, the defect candidate extraction section is configured to perform blob detection processing for extracting, as a defect candidate portion, a portion at which a density value is equal to or smaller than a predetermined value, is equal to or larger than the predetermined value, is within a predetermined range, or is out of the predetermined range by binarization based on the density value.

According to this invention, it is possible to extract the candidate portions at which the defect may be present at a high speed by the normal inspection processing, and it is possible to increase an ability to cope with the complicated determination by applying the deep learning processing having a high processing load to only the extracted candidate portions.

### BRIEF DESCRIPTION OF THE DRAWINGS

FIG. 1 is a schematic diagram illustrating a configuration of an image inspection apparatus according to an embodiment of the present invention;

FIG. 2 is a diagram illustrating a hardware configuration of the image inspection apparatus;

FIG. 3 is a block diagram of the image inspection apparatus;

FIG. 4 is a diagram illustrating a specific example of a non-defective product image and a defective product image;

FIG. 5 is a diagram for describing an example in which designation of a region of a learning image including a defect is received;

FIG. 6 is a diagram for describing a case where an image including a plurality of defects in one image is used as the learning image;

FIG. 7 is a diagram illustrating a case where one defect candidate portion is extracted by flaw detection processing;

FIG. 8 is a diagram illustrating a case where two defect candidate portions are extracted by the flaw detection processing;

FIG. 9 is a diagram illustrating a case where the defect candidate portion is extracted by blob detection processing;

FIG. 10 is a flowchart illustrating a determination procedure when a two-class determination is performed;

FIG. 11 is a flowchart illustrating a determination procedure when a multi-class determination is performed;

FIG. 12 is a flowchart illustrating a determination procedure when an obvious defective product is determined by the normal inspection processing and the remaining product is determined by the deep learning processing;

FIG. 13 is a diagram illustrating an example when the normal inspection processing and the deep learning processing are incorporated into the image inspection apparatus;

FIG. 14 is a measurement unit displaying user interface;

FIG. 15 is a control unit displaying user interface; and

FIG. 16 is a position correction unit displaying user interface.

### DETAILED DESCRIPTION OF PREFERRED EMBODIMENTS

Hereinafter, an embodiment of the present invention will be described in detail with reference to the drawings. It should be noted that the following description of preferred embodiments is merely an example in nature, and is not intended to limit the present invention, the application thereof, or the purpose of use thereof.

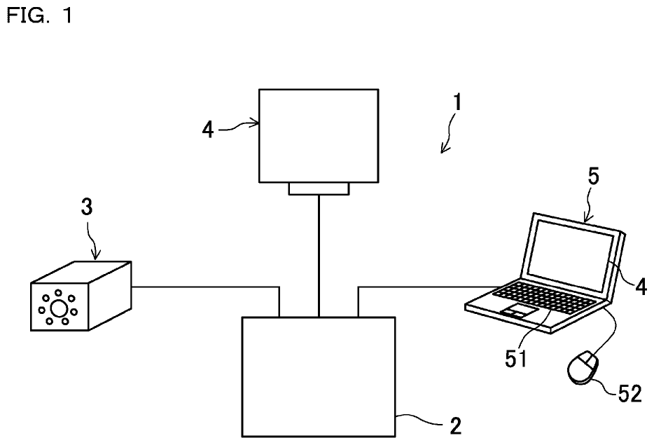

FIG. 1 is a schematic diagram illustrating a configuration of an image inspection apparatus 1 according to an embodiment of the present invention. The image inspection apparatus 1 is an apparatus that performs a quality determination of an inspection target based on an inspection target image acquired by capturing the inspection target such as various components or products, and can be used at a production site such as a factory. The entire inspection target may be the target of inspection, or only a part of the inspection target may be the target of the inspection. One inspection target may include a plurality of targets of inspection. The inspection target image may include a plurality of inspection targets. The inspection target can also be called a workpiece.

The image inspection apparatus 1 includes a control unit 2 serving as an apparatus main body, an imaging unit 3, a display device (display unit) 4, and a personal computer 5. The personal computer 5 is not essential, and may be omitted. Various information and images can be displayed by using the personal computer 5 instead of the display device 4. It has been illustrated in FIG. 1 that the control unit 2, the imaging unit 3, the display device 4, and the personal computer 5 are described as separate units as an example of a configuration example of the image inspection apparatus 1, but a plurality of components thereof may also be combined and integrated. For example, the control unit 2 and the imaging unit 3 can be integrated, or the control unit 2 and the display device 4 can be integrated. The control unit 2 may be divided into a plurality of units, and a part of the divided units may be incorporated in the imaging unit 3 or the display device 4. Alternatively, the imaging unit 3 may be divided into a plurality of units, and a part of the divided units may be incorporated in another unit.

(Configuration of Imaging Unit 3)

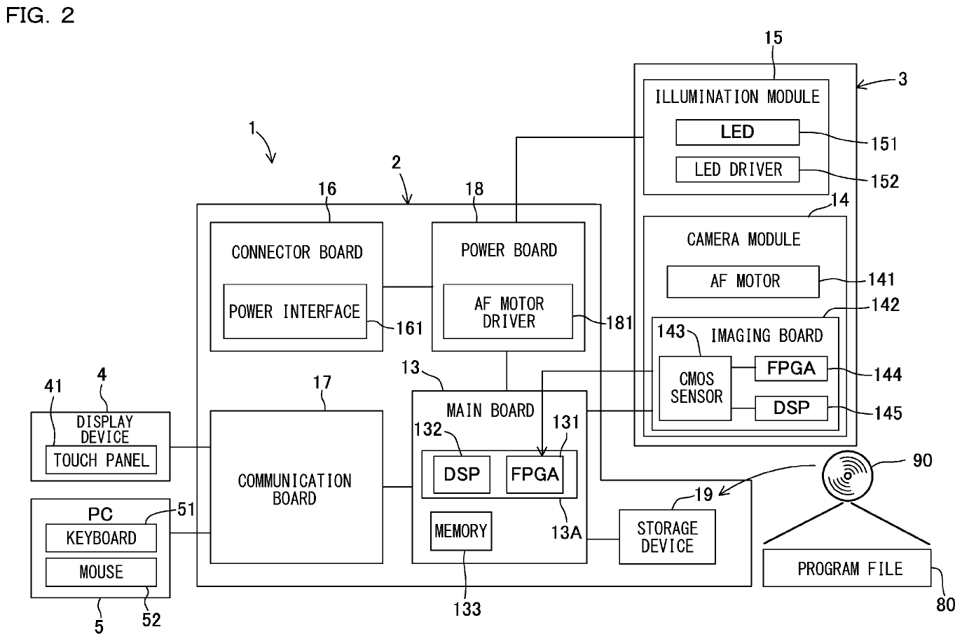

As illustrated in FIG. 2, the imaging unit 3 includes a camera module (imaging unit) 14 and an illumination module (illumination unit) 15, and is a unit that executes the acquisition of the inspection target image.

The camera module 14 includes an AF motor 141 that drives an imaging optical system, and an imaging board 142. The AF motor 141 is a part that automatically performs focus adjustment by driving a lens of the imaging optical system, and can perform focus adjustment by a method such as contrast autofocus known in the related art. An imaging visual field range (imaging region) using the camera module 14 is set so as to include the inspection target. The imaging board 142 includes a CMOS sensor 143, an FPGA 144, and a DSP 145 as light receiving elements for receiving light incident from the imaging optical system. The CMOS sensor 143 is an imaging sensor configured to acquire a color image. For example, a light receiving element such as a CCD sensor may be used instead of the CMOS sensor 143. The FPGA 144 and the DSP 145 are used for executing image processing within the imaging unit 3, and a signal output from the CMOS sensor 143 is also input to the FPGA 144 and the DSP 145.

The illumination module 15 includes a light emitting diode (LED) 151 as a light emitter that illuminates an imaging region including the inspection target, and an LED driver 152 that controls the LED 151. A light emission timing, a light emission time, and a light emission amount of the LED 151 can be arbitrarily set by the LED driver 152. The LED 151 may be provided integrally with the imaging unit 3, or may be provided as an external illumination unit separately from the imaging unit 3. Although not illustrated, a reflector that reflects light emitted from the LED 151, a lens through which the light emitted from the LED 151 passes are provided in the illumination module 15. An emission range of the LED 151 is set such that the light emitted from the LED 151 is emitted to the inspection target and the surrounding region of the inspection target. Light emitters other than the light emitting diode may also be used.

(Configuration of Control Unit 2)

The control unit 2 includes a main board 13, a connector board 16, a communication board 17, and a power board 18. An FPGA 131, a DSP 132, and a memory 133 are mounted on the main board 13. The FPGA 131 and the DSP 132 constitute a control unit 13A, and a main control unit in which these components are integrated may be provided.

The control unit 13A of the main board 13 controls operations of each connected board and module. For example, the control unit 13A outputs an illumination control signal for controlling the turning on and off of the LED 151 to the LED driver 152 of the illumination module 15. The LED driver 152 switches between the turning on and off of the LED 151 and adjusts a turning-on time and adjusts a light amount of the LED 151 according to the illumination control signal from the control unit 13A.

The control unit 13A outputs an imaging control signal for controlling the CMOS sensor 143 to the imaging board 142 of the camera module 14. The CMOS sensor 143 starts imaging and performs imaging by adjusting an exposure time to any time according to the imaging control signal from the control unit 13A. That is, the imaging unit 3 captures a region within the visual field range of the CMOS sensor 143 according to the imaging control signal output from the control unit 13A. When the inspection target is present within the visual field range, the imaging unit captures the inspection target, and when an object other than the inspection target is present within the visual field range, the imaging unit also captures this object. For example, when the image inspection apparatus 1 is set, it is possible to capture a non-defective product image to which an attribute as a non-defective product is given by a user and a defective product image to which an attribute of a defective product is given. At the time of running the image inspection apparatus 1, the inspection target can be captured. The CMOS sensor 143 is configured to output a live image, that is, a currently captured image at a short frame rate as needed.

When the imaging using the CMOS sensor 143 is ended, an image signal output from the imaging unit 3 is input to the FPGA 131 of the main board 13, is processed by the FPGA 131 and the DSP 132, and is stored in the memory 133. Details of specific processing contents using the control unit 13A of the main board 13 will be described below.

The connector board 16 is a part that receives a power from the outside via a power connector (not illustrated) provided at a power interface 161. The power board 18 is a part that distributes the power received by the connector board 16 to each board and module, and specifically, distributes the power to the illumination module 15, the camera module 14, the main board 13, and the communication board 17. The power board 18 includes an AF motor driver 181. The AF motor driver 181 supplies a driving power to the AF motor 141 of the camera module 14, and realizes autofocus. The AF motor driver 181 adjusts the power supplied to the AF motor 141 according to an AF control signal from the control unit 13A of the main board 13.

The communication board 17 outputs a quality determination signal, image data, and a user interface of the inspection target output from the control unit 13A of the main board 13 to the display device 4, the personal computer 5, and an external control device (not illustrated). The display device 4 and the personal computer 5 include a display panel constituted by, for example, a liquid crystal panel, and displays the image data and the user interface on the display panel.

The communication board 17 is configured to receive various operations of the user input from a touch panel 41 of the display device 4 and a keyboard 51 of the personal computer 5. The touch panel 41 of the display device 4 is, for example, a touch type operation panel having a pressure sensitive sensor mounted thereon known in the related art, detects a touch operation of the user, and outputs the detected touch operation to the communication board 17. The personal computer 5 includes the keyboard 51 and a mouse 52 as operation devices. The personal computer 5 may include a touch panel (not illustrated) as the operation device. The personal computer 5 is configured to receive various operations of the user input from these operation devices. Communication may be wired or wireless, and any communication form can be realized by a communication module known in the related art.

A storage device 19 such as a hard disk drive is provided in the control unit 2. The storage device 19 stores a program file 80 and a setting file (software) for causing each control and processing to be described below to be executable by the hardware. For example, the program file 80 and the setting file can be stored in a storage medium 90 such as an optical disk, and the program file 80 and the setting file stored in the storage medium 90 can be installed in the control unit 2. The storage device 19 can store the image data and a quality determination result.

(Specific Configuration of Image Inspection Apparatus 1)

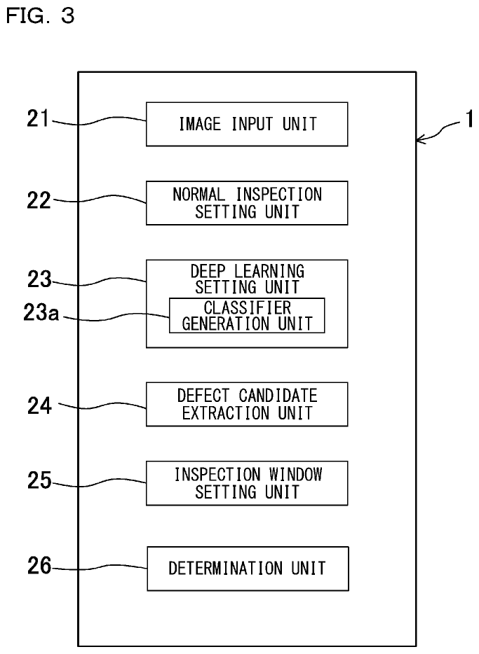

FIG. 3 is a block diagram of the image inspection apparatus 1, and each unit illustrated in FIG. 3 is realized by the control unit 2 in which the program file 80 and the setting file are installed. That is, the image inspection apparatus 1 includes an image input unit 21, a normal inspection setting unit (an example of a normal inspection setting section) 22, a deep learning setting unit (an example of a deep learning setting section) 23, a defect candidate extraction unit 24, an inspection window setting unit 25, and a determination unit 26 (an example of a determination section). These units 21 to 26 and sections may be constituted only by hardware, or may be constituted by a combination of hardware and software.

Although each of the units 21 to 26 illustrated in FIG. 3 is conceptually independent, any two or more units may be integrated, and the present invention is not limited to the illustrated form.

Each of the units 21 to 26 and the sections may be constituted by independent hardware, or may be configured such that a plurality of functions is realized by one piece of hardware or software. Functions and actions of the units 21 to 26 and the sections illustrated in FIG. 3 can also be realized under the control of the control unit 13A of the main board 13.

The image inspection apparatus 1 is configured to perform at least two types of inspections, that is, an inspection of the inspection target through normal inspection processing and an inspection of the inspection target through deep learning processing. The normal inspection processing is general inspection processing using an image obtained by capturing the inspection target, and is processing for performing the quality determination of the inspection target based on various characteristic amounts (color, edge, and position) of the inspection target within the image.

Meanwhile, the deep learning processing is inspection processing using a learned neural network obtained by adjusting a plurality of parameters within the network such that the non-defective product image and the defective product image are discriminable by inputting at least one of an image to which a plurality of non-defective product attributes is given in advance and an image to which defective product attributes are given to a multilayer neural network. The neural network used herein has three or more layers, and is a neural network capable of performing so-called deep learning. In the deep learning processing, the learning can be performed such that the type of a defect is discriminable by using a learning image including the defect, and in this case, not only classification of the quality but also the classification according to the type of the defect can be performed.

Although details will be described below, when a stable inspection is performed by only one inspection processing of the normal inspection processing and the deep learning processing, only one inspection processing is executable. In addition, for example, an inspection that is difficult to determine by the normal inspection processing can be determined with high accuracy by the deep learning processing by using both the normal inspection processing and the deep learning processing. An unstable behavior in which an unexpected defect peculiar to the deep learning processing that may occur when unknown data not used for learning is input is mixed can be avoided by the inspection processing of only the normal inspection processing.

The image inspection apparatus 1 is switched between a setting mode in which various parameter settings such as an imaging setting, registering of a master image, setting of the normal inspection processing, and setting of the deep learning processing are performed and a running mode (Run mode) in which the quality determination of the inspection target is performed based on the inspection target image obtained by capturing the inspection target in an actual site. In the setting mode, the user can perform a preparatory work so as to separate the non-defective product from the non-defective product in a desired product inspection, and a learning work of the neural network is included in this work. The switching between the setting mode and the running mode is executable on a user interface (not illustrated), and can also be configured to automatically transition to the running mode simultaneously with the completion of the setting mode. The transition from the running mode to the setting mode can be arbitrarily performed. In the running mode, the neural network can be re-learned.

(Configuration of Image Input Unit 21)

In the setting mode, the image input unit 21 illustrated in FIG. 3 is a part that inputs a learning image including an inspection target to the deep learning setting unit 23 and a part that inputs a registration image to the normal inspection setting unit 22. The image input unit 21 is also a part that inputs a newly acquired inspection target image to the defect candidate extraction unit 24 in the running mode. The learning image includes a plurality of non-defective product images to which non-defective attributes are given and/or a plurality of defective product images to which defective attributes are given.

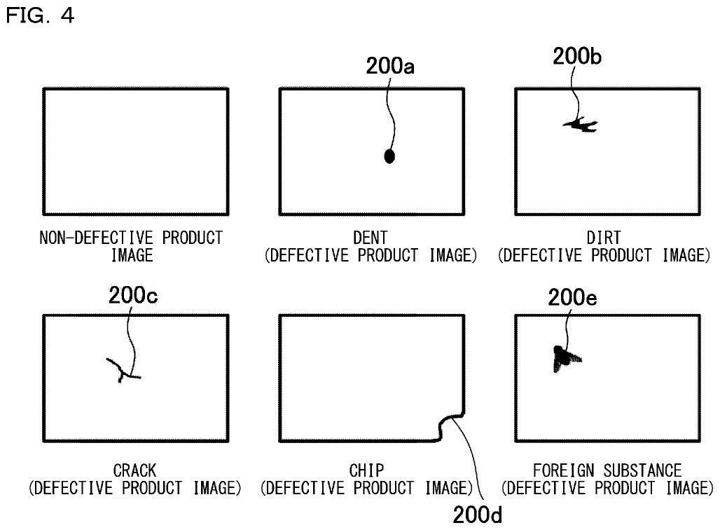

FIG. 4 illustrates a plurality of types of images captured by the imaging unit 3 and can be roughly classified into the non-defective product image obtained by capturing the non-defective product and the defective product image obtained by imaging the defective product. The non-defective product is an inspection target having no defect in principle. However, the inspection target may be set as the non-defective product when the inspection target has a small defect, or may be the non-defective product when the inspection target has a predetermined defect (dirt to be described below). The setting of the non-defective product can be performed by the user. Meanwhile, the defective product is an inspection target having a defect that the user wants to handle as a defect. The defect is, for example, dent, dirt, crack, chip, and foreign substance, but there are other states that can be called the defect.

In the example illustrated in FIG. 4, an image obtained by capturing an inspection target not having a dent 200a, a dirt 200b, a crack 200c, a chip 200d, and a foreign substance 200e is classified as the non-defective product image, and an image obtained by capturing an inspection target having at least one of the dent 200a, the dirt 200b, and the crack 200c, the chip 200d, and the foreign substance 200e is classified as the defective product image. The method of classifying the non-defective product image and the defective product image is not limited thereto. For example, there are various classification methods such as a method of classifying the inspection target having the dirt 200b into the non-defective product when there are not the dent 200a, the crack 200c, the chip 200d, and the foreign substance 200e and a method of classifying only the inspection target having the plurality of defects into the defective product.

The method of obtaining the image is described in detail. In the setting mode, when the user places the inspection target in the visual field of the CMOS sensor 143 of the imaging unit 3, the control unit 13A incorporates the live image captured by the CMOS sensor 143 in a part of an image inputting user interface (not illustrated), and displays the image inputting user interface in which the live image is incorporated on the display device 4. When the user performs an image obtaining operation in a state in which the inspection target is displayed on the image inputting user interface, an image displayed on the image inputting user interface at this point of time, that is, an image desired to be obtained by the user are obtained as still images. The obtained images are stored in the memory 133 or the storage device 19. Examples of the image obtaining operation of the user include a button operation incorporated in the image inputting user interface and operations of the keyboard 51 and the mouse 52.

The user can give one of the non-defective product attribute and the defective product attribute to the image when the image is obtained. For example, a “non-defective product obtaining button” and a “defective product obtaining button” are provided in the image inputting user interface. When the image displayed on the image inputting user interface is obtained, in a case where a “non-defective product obtaining button” operation is performed, the image obtained at this point of time can be obtained as the non-defective product image to which the non-defective product attribute is given, and in a case where a “defective product obtaining button” operation is performed, the image obtained at this point of time can be obtained as the non-defective product image to which the defective product attribute is given. By repeating this, the plurality of non-defective product images and a plurality of defective product images can be obtained. When the plurality of non-defective product images is input, the input images may be images obtained by capturing different non-defective products, or may be images obtained by capturing one non-defective product multiple times while changing an angle and a position of one non-defective product. The plurality of non-defective product images and the plurality of defective product images may be generated by, for example, changing brightness of the image within the image inspection apparatus 1. The non-defective product image and the defective product image are prepared as, for example, about 100 images, respectively. For example, when a flaw is detected, a defective product image with a flaw is prepared. This defective product image may be created by the user, or may be automatically created by the image inspection apparatus 1.

As the learning image, only the non-defective product image or only the defective product image can be obtained. The method of giving the non-defective product attribute and the defective product attribute to the image is not limited to the aforementioned method, and may be, for example, a method of giving the attribute after the image is obtained. It is also possible to correct the attributes after the non-defective product attribute and the defective product attribute are given.

The learning image including the dent is a dent image, the learning image including the dirt is a dirt image, the learning image including the crack is a crack image, the learning image including the chip is a chip image, and the learning image including the foreign substance is a foreign substance image. In this manner, defect attributes can be given to the images. The method of giving the defect attribute can be identical to the method of giving the non-defective product and defective product attributes.

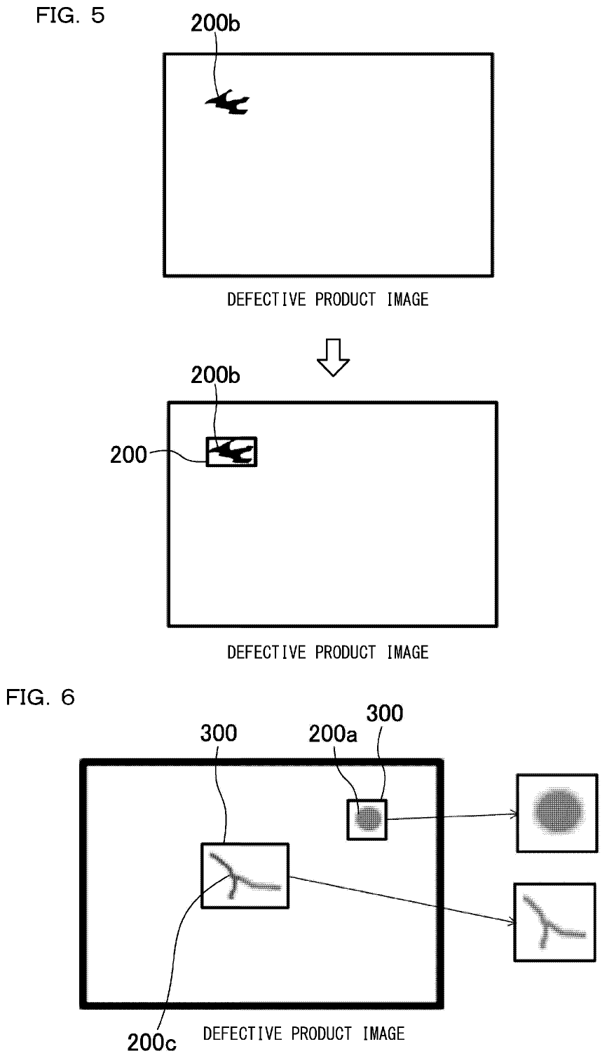

When the learning image is obtained, the designation of a region including the defect in the learning image may be received. FIG. 5 illustrates a state in which the defective product image is displayed on the image inputting user interface, an upper side of FIG. 5 illustrates the image obtained by capturing the inspection target including the dirt 200b as the defect as it is, and a lower side of FIG. 5 illustrates a state in which the designation of a region including the dirt 200b is received. A reference sign 300 denotes a defect region window set so as to surround an area including the dirt 200b. A defect region window 300 can be set by the user. For example, the defect region window 300 can be set by drawing a rectangle surrounding the dirt 200b by operating the mouse 52 on the image obtained by capturing the inspection target displayed on the image inputting user interface. This rectangular shape can be a circumscribed rectangular shape of the dirt 200b. For example, the defective region window 300 can be set by dragging the mouse 52 to the lower left or lower right while placing a pointer of the mouse 52 on the upper right or upper left of the dirt 200b. The size of the defect region window 300 can be adjusted after the setting. The dirt 200b is an example, and may be any of the dent 200a, the crack 200c, the chip 200d, and the foreign substance 200e. As illustrated in FIG. 6, when one image has the plurality of defects, for example, the dent 200a and the crack 200c, the defect region window 300 can be set so as to surround each of the defects.

After the designation of the region including the defect is received, the type of the defect in the region can be input. The types of the defects are, for example, the dent 200a, the dirt 200b, the crack 200c, the chip 200d, and the foreign substance 200e, and when the type of the defect in the defect region window 300 is input from these defects, the type of the defect and the region within the defect region window 300 are stored in association with each other in the storage device 19. When there is the plurality of types of defects in one image, the type can be input for each defect.

The user can obtain the registration image used in the normal inspection processing as the master image. For example, the registration image can be used when the difference inspection in which the quality determination is performed by detecting a blob (lump) of a difference from a newly acquired inspection target image. The registration image can be used when the quality determination is performed by using a normalized correlation. For example, a “registration image obtaining button” is provided in the image inputting user interface. When the image displayed on the image inputting user interface is obtained, in a case where the “registration image obtaining button” operation is performed, the image obtained at this point of time can be the registration image. After the image is obtained, the obtained image can be set as the registration image.

In the running mode, the control unit 13A obtains the inspection target image by capturing the inspection target by the CMOS sensor 143 in a state in which the inspection target is within the visual field of the CMOS sensor 143. The signal serving as a trigger for obtaining the inspection target image is known in the related art, and may be, for example, a signal input from outside the image inspection apparatus 1 or a signal generated inside the image inspection apparatus 1.

(Configuration of Normal Inspection Setting Unit 22)

The normal inspection setting unit 22 is a part that performs the setting of the normal inspection processing by receiving setting of the characteristic amount used for the normal inspection and setting of a normal inspection threshold which is a criterion of the quality determination to be compared with the characteristic amount from the user. The characteristic amount used for the normal inspection includes, for example, a color of the inspection target, an edge of the inspection target, and a position of the inspection target. Edge information of the inspection target includes a position, a shape, and a length of the edge. The position of the inspection target includes not only the position of the inspection target itself but also a position of a part of the inspection target. The number of characteristic amounts used for the normal inspection may be one, or two or more.

When the characteristic amount used for the normal inspection is set, a characteristic amount setting user interface (not illustrated) generated by the control unit 13A is displayed on the display device 4, and the operation of the user is received on the user interface for setting the characteristic amount. A characteristic amount setting unit for inputting and selecting the above-described characteristic amount is provided on the characteristic amount setting user interface. When the user performs an input operation on the characteristic amount setting unit by using the keyboard 51 and the mouse 52, the input operation is received by the control unit 13A, and the setting of the characteristic amount used for the inspection is completed. The set characteristic amount is stored in the memory 133 or the storage device 19.

The characteristic amount set as described above is compared with a normal inspection threshold which is a criterion for determining whether or not to set a defect candidate portion, and the defect candidate extraction unit 24 to be described below determines whether the inspection target image is the defect candidate portion as a comparison result. When the normal inspection threshold which is the criterion of the defect candidate portion determination used at this time is set, a threshold setting user interface (not illustrated) generated by the control unit 13A is displayed on the display device 4, and the operation of the user is received on the threshold setting user interface. A threshold input unit for inputting the normal inspection threshold is provided on the threshold setting user interface. When the user performs a threshold input operation on the threshold input unit by using the keyboard 51 or the mouse 52, the input operation is received by the control unit 13A, and the input and setting of the threshold are completed. The set normal inspection threshold is stored in the memory 133 or the storage device 19. A final input may be completed by automatically setting the normal inspection threshold by the image inspection apparatus 1 and then adjusting the set normal inspection threshold by the user. The normal inspection threshold is a threshold used in the normal inspection processing, and is not used in the inspection of the deep learning processing.

When the normal inspection threshold is received from the user, a non-defective product confirming threshold for confirming a non-defective product determination and a defective product confirming threshold for confirming a defective product determination may be received.

The non-defective product confirming threshold is a threshold for determining that the product is the non-defective product when the comparison result is equal to or larger than the threshold or the product is the non-defective product when the comparison result is equal to or smaller than the threshold by using this threshold as a criterion. A threshold having high accuracy with which the product is confirmable as the non-defective product can be set. Meanwhile, the defective product confirming threshold is a threshold for determining that the product is the defective product when the comparison result is equal to or larger than the threshold or the product is the defective product when the comparison result is equal to or smaller than the threshold by using this threshold as a criterion. A threshold having high accuracy with which the product is confirmable as the defective product can be set. Any one of the non-defective product confirming threshold or the defective product confirming threshold may be received, or both may be received. When the non-defective product confirming threshold and the defective product confirming threshold are input, these thresholds are stored in the memory 133 and the storage device 19 in a discriminable state.

The normal inspection processing includes flaw detection processing and blob detection processing, but may include other normal inspection processing. The flaw detection processing is processing described in Japanese Patent No. 4544578, and is processing for extracting a portion at which a predetermined difference or more from the surroundings is generated as a flaw (defect candidate portion) based on a segmented average density value. The blob detection processing is processing for extracting, as the defect candidate portion, a portion at which the density value is equal to or smaller than a predetermined value, is equal to or larger than the predetermined value, is within a predetermined range, or is out of the predetermined range by binarization based on the density value. The normal inspection processing can be performed on the entire inspection target image, or can be performed only on a predetermined range. A plurality of defect candidate portions may be extracted by the normal inspection processing.

In both the flaw detection processing and the blob detection processing, it is possible to distinguish between the defects in a case where a difference between the density values of the defect that the user wants to detect and the defect that the user does not want to detect is large or there is a difference in shape characteristics, but it is difficult to distinguish between the defects in other cases. That is, the shape characteristics include, for example, a fillet diameter which is a length of a side parallel to an X-axis and a Y-axis of a rectangle circumscribing the blob, a circularity indicating how similar the blob is to a perfect circle, and a length of the surrounding of the blob. However, when there is no difference in these shape characteristics, it is difficult to extract the defect candidate portion in the flaw detection processing and the blob detection processing, and it is particularly difficult to distinguish between “dirt” and “foreign substance” such as insects by only the shape characteristic amount of the related art.

(Configuration of Deep Learning Setting Unit 23)

The deep learning setting unit 23 has a classifier generation unit 23a. The classifier generation unit 23a is a part that sets the deep learning processing for inputting the learning image to an input layer of the neural network, causing the neural network to learn, and classifying the newly acquired inspection target images into a first class and a second class. In the setting of the deep learning processing, a classifier that classifies the newly acquired inspection target images into the first class and the second class can be generated by the classifier generation unit 23a. The neural network can be constructed on the control unit 13A, and has at least an input layer, an intermediate layer, and an output layer.

When the plurality of non-defective product images to which the non-defective product attributes are given and/or the plurality of defective product images to which the defective product attributes are given are input as the learning image to the input layer of the neural network, the classifier that classifies the newly acquired inspection target images into the non-defective product image and the defective product image is generated by the classifier generation unit 23a of the deep learning setting unit 23. In this case, the first class is a non-defective product image class into which the non-defective product image is classified, and the second class is a defective product image class into which the defective product image is classified.

Since the non-defective product image and the defective product image are acquired by the image input unit 21, the deep learning setting unit 23 inputs the non-defective product image and the defective product image acquired by the image input unit 21 to the input layer of the neural network. In the input layer of the neural network, only the non-defective product image may be input, only the defective product image may be input, or both the non-defective product image and the defective product image may be input. Such an input may be automatically changed according to an image acquisition status, or may be selected by the user.

The deep learning setting unit 23 also provides correct answer information (whether the input image is the non-defective product or the defective product) to the neural network, and causes the neural network to learn by using the plurality of non-defective product images and/or the plurality of defective product images and the correct answer information. Accordingly, parameters having a high correct answer rate are obtained by changing a plurality of initial parameters of the neural network. The learning of the neural network can be automatically performed at a point of time when the non-defective product image or the defective product image is input. The neural network learns, and thus, the classifier capable of classifying the non-defective product image and the defective product image is generated.

The neural network may be a discrimination type network based on a convolutional neural network (CNN) or a restoration type neural network represented by an auto encoder. In the case of the discrimination type network, a value (a normalization function called a softmax function is generally used) obtained by normalizing an output value can be set as a threshold (deep learning processing threshold) which is the criterion of the quality determination. The deep learning processing threshold can include a non-defective product determining threshold which is a criterion of the non-defective product determination and a defective product determining threshold which is a criterion of the defective product determination, and a value obtained by normalizing any of these thresholds can be used. The deep learning processing threshold and the normal inspection threshold are independent.

In the case of the restoration type neural network, particularly, the auto encoder, for example, the learning is executable in advance such that non-defective product image data is input in the setting mode and the input data is restored and output with no change. In the running mode, the newly acquired inspection target image is input to the learned neural network, and the input image is obtained as a restored image. A difference between the image input to the neural network and the restored image is obtained, and when the difference is equal to or larger than a predetermined value, it is possible to determine that the product is the defective product, and when the difference is smaller than the predetermined value, it is possible to determine that the product is the non-defective product. There are a method of determining the sum of differences between gradation values of the images input to the neural network and the restored images and a method of determining the sum of the number of pixels of which a difference is equal to or larger than a predetermined value. As described above, the deep learning processing threshold may be decided by using the number of pixels or an area of the image.

The first class may be a first defect class into which an image including a first defect is classified, and the second class may be a second defect class into which an image including a second defect is classified. In this case, in the setting mode, the classifier generation unit 23a inputs, as the learning image, the plurality of images including the first defect and the plurality of images including the second defect to the input layer of the neural network, and causes the neural network to learn. Accordingly, the classifier that classifies the inspection target image into the first defect class and the second defect class is generated. The first defect or the second defect may include the plurality of types of defects.

The first defect may include any one or two or more of the aforementioned dent, dirt, crack, chip, and foreign substance, and the second defect may include any one or two or more of defects other than the first defect. The plurality of images including the first defect and the plurality of images including the second defect are input to the input layer of the neural network, and correct information (the defect corresponding to the input image) is provided to the neural network. Thus, it is possible to generate the classifier capable of accurately classifying the first defect class and the second defect class by changing the parameters of the neural network.

In the setting mode, the classifier generation unit 23a inputs the plurality of learning images including the dent 200a, the dirt 200b, the crack 200c, the chip 200d, and the foreign substance 200e to the input layer of the neural network, and can cause the neural network to learn such that the dent 200a, the dirt 200b, the crack 200c, the chip 200d, and the foreign substance 200e are discriminable. In this case, it is possible to generate the classifier that not only detects that the defect is included in the inspection target image input in the running mode but also determines the type of the defect and classifies the defect for each type. The type of the defect includes the dent 200a, the dirt 200b, the crack 200c, the chip 200d, and the foreign substances 200, but may include other types of defects.

In the setting mode, the classifier generation unit 23a may be configured to input, as the learning image, the plurality of images including the plurality of defects in one image to the input layer of the neural network and cause the neural network to learn. As illustrated in FIG. 6, for example, the classifier that classifies the image including the dent and the crack can be generated by inputting the image including the dent 200a and the crack 200b into one image into the input layer of the neural network.

In the setting mode, the classifier generation unit 23 can be configured to input the plurality of regions including the defect in the learning image to the input layer of the neural network and cause the neural network to learn. In this case, as illustrated in FIG. 5, a region surrounded by the defect region window 300 is input to the input layer of the neural network. Information related to the type of defect input as the correct information to the input layer is provided to the neural network, and thus, the learning including the type of the defect in the region surrounded by the defect region window 300 can be performed.

The classifier generation unit 23 is configured to perform normalization processing on the image size input to the input layer of the neural network in the setting mode. That is, an inputtable image size is defined in the neural network, and the image size within the defect region window 300 is normalized so as to be the image size. However, when the normalization processing is performed by enlarging the image, in a case where an enlargement ratio of the image is too high, since a noise component included in the image is increased and easily becomes a cause of an erroneous determination, it is preferable that an upper limit of the enlargement ratio is restricted. The classifier generation unit 23 sets the enlargement ratio during the normalization processing to be equal to or lower than a predetermined value, and thus, it is difficult to cause the erroneous determination by suppressing an increase in the noise component.

(Configuration of Defect Candidate Extraction Unit 24)

The defect candidate extraction unit 24 is a part that extracts the defect candidate portion that may be the defect based on a pixel value of the inspection target image input by the image input unit 21. The defect candidate extraction unit 24 can be configured to perform the flaw detection processing for extracting, as the defect candidate portion, the portion at which a predetermined difference or more from the surroundings is generated based on the segmented average density value, and also perform the blob detection processing for extracting, as the defect candidate portion, the portion at which the density value is equal to or smaller than the predetermined value, is equal to or larger than the predetermined value, is within the predetermined range, or is out of the predetermined range by binarization based on the density value. The processing loads of the flaw detection processing and the blob detection processing are lower than that of the deep learning processing, and high-speed processing can be performed.

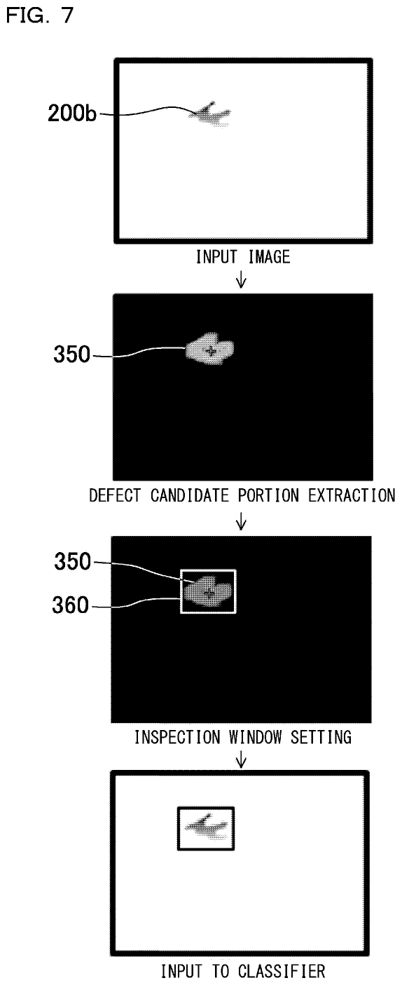

In the case of the flaw detection processing, as illustrated in FIG. 7, when the image including the dirt 200b is input from the image input unit 21, the defect candidate extraction unit 24 performs the processing for extracting the portion at which the predetermined difference or more from the surroundings is generated based on the segmented average density value. The portion extracted by this processing is a defect candidate portion 350. A threshold used when the defect candidate portion 350 is extracted is set such that a suspicious portion can be extracted as the defect candidate portion 350 even though the portion may not be finally the defect. Thus, this prevents the extraction omission of the defect.

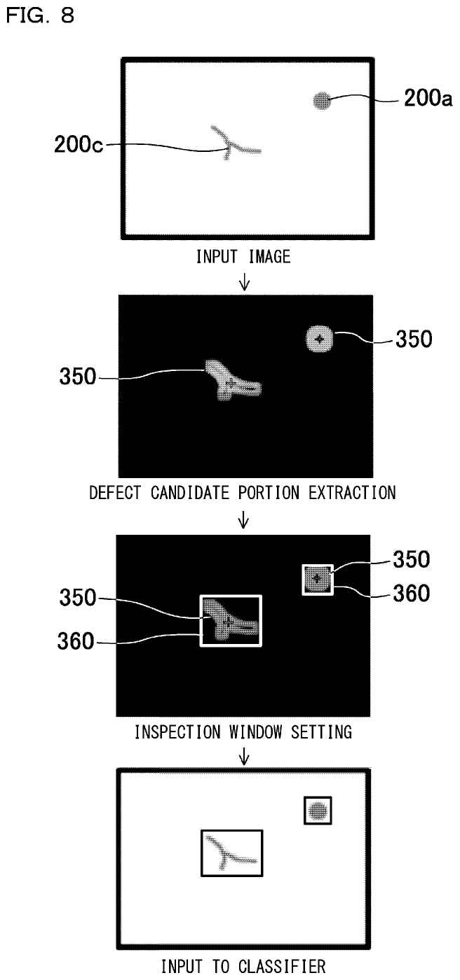

FIG. 8 is a diagram illustrating a case where the image including the dent 200a and the crack 200c is input from the image input unit 21. Similar to the case illustrated in FIG. 7, the defect candidate extraction unit 24 performs the processing for extracting the portion at which the predetermined difference or more from the surroundings is generated based on the segmented average density value. In this example, since the dent 200a and the crack 200c are included, two defect candidate portions 350 and 350 are extracted.

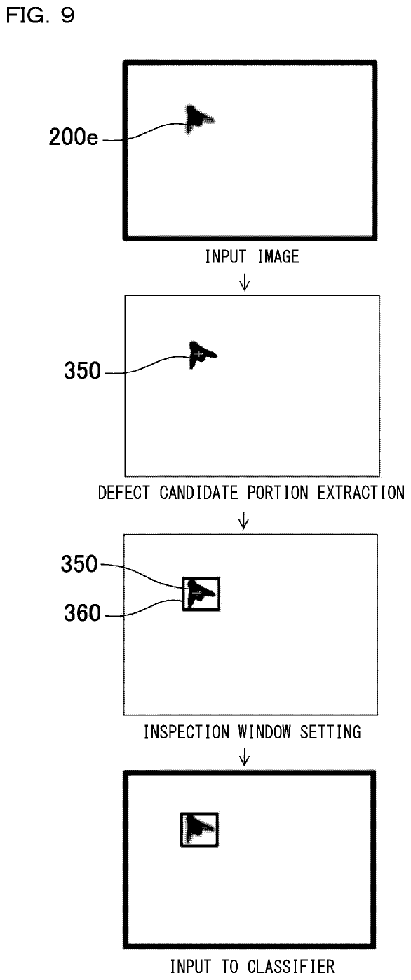

In the case of the blob detection processing, as illustrated in FIG. 9, when the image including the foreign substance 200e is input from the image input unit 21, the defect candidate extraction unit 24 performs the processing for extracting the portion at which the density value is equal to or smaller than the predetermined value, is equal to or larger than the predetermined value, is within the predetermined range, or is out of the predetermined range by binarization based on the density value. The portion extracted by this processing is a defect candidate portion 350. Similar to the case of the flaw detection processing, the threshold used when the defect candidate portion 350 is extracted is set so as to prevent the extraction omission of the defect.

(Configuration of Inspection Window Setting Unit 25)

The inspection window setting unit 25 sets an inspection window in the region including the defect candidate portion 350 extracted by the flaw detection processing or the blob detection processing. As illustrated in FIG. 7, the inspection window setting unit 25 sets an inspection window 360 having a circumscribed rectangular shape surrounding the defect candidate position 350 extracted by the flaw detection processing. That is, the size and position of the defect candidate portion 350 can be acquired from the defect candidate extraction unit 24, and a rectangular inspection window 360 capable of including all the defect candidate portions 350 is automatically set based on the size and position of the defect candidate portion 350 acquired from the defect candidate extraction unit 24. The shape of the inspection window 360 is not limited to the rectangular shape, but may be any shape capable of surrounding the defect candidate portion 350. Similar to the case of setting the defect region window 300 illustrated in FIG. 5, the inspection window 360 may be manually set by the user.

As illustrated in FIG. 8, when two defect candidate portions 350 and 350 are extracted, the inspection window 360 is set for each of the two defect candidate portions 350 and 350. The inspection window 360 can be set according to the number of defect candidate portions 350. When a plurality of defect candidate portions 350 is extracted and these defect candidate portions are close to each other, the inspection window 360 may be set such that the plurality of defect candidate portions 350 is surrounded by one inspection window 360.

As illustrated in FIG. 9, the inspection window 360 can be set in the region including the defect candidate portion 350 extracted by the blob detection processing.

(Configuration of Determination Unit 26)

The determination unit 26 is a part that determines whether or not the inspection target image is classified into any one of the first class and the second class by inputting the image within the inspection window 360 set by the inspection window setting unit 25 to the classifier generated by the classifier generation unit 23a, and performs the determination in the running mode. When the first class is the non-defective product image class and the second class is the defective product image class, the determination unit 26 determines into which of the non-defective product image class and the defective product image class the image is classified. When the first class is the first defect class and the second class is the second defect class, the determination unit 26 determines whether the inspection target image is classified into the first defect class or the second defect class.

As described above, when the classifier is generated such that the dent 200a, the dirt 200b, the crack 200c, the chip 200d, and the foreign substance 200e can be determined, the determination unit 26 can determine whether or not the defect is classified into any type by determining the type of the defect.

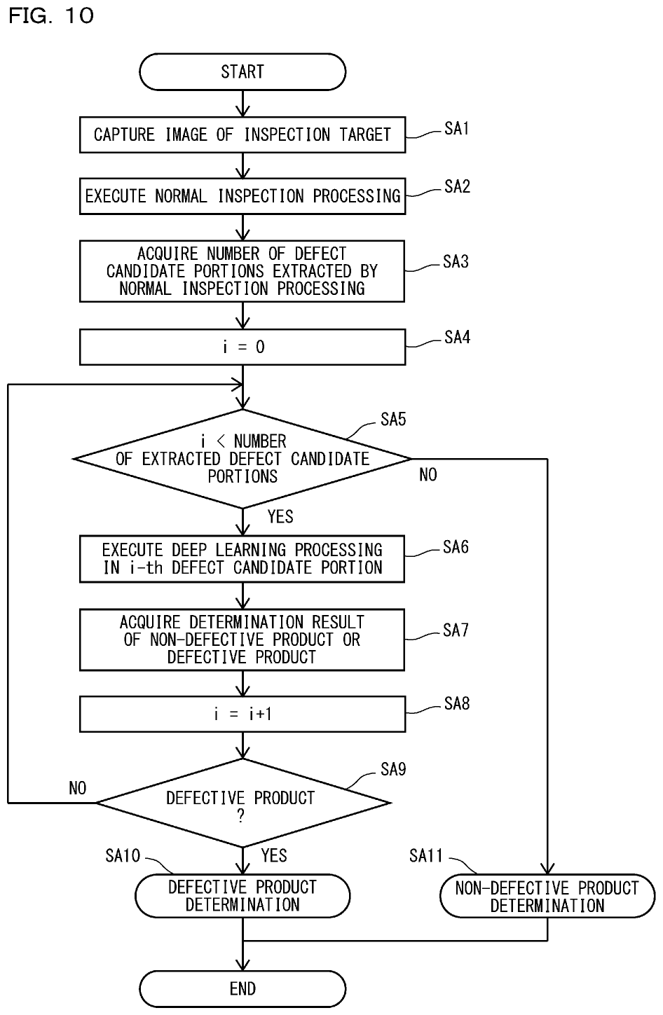

Hereinafter, a determination procedure using the determination unit 26 will be described with reference to a flowchart. FIG. 10 is a flowchart illustrating a determination procedure when two-class determination is performed. After the start of the flowchart, the inspection target is captured in step SA1. The control unit 13A controls the CMOS sensor 143, and thus, the inspection target can be captured. Specifically, the inspection target is captured by the image input unit 21 illustrated in FIG. 3. In step SA2, the defect candidate extraction unit 24 performs the normal inspection processing, that is, the flaw inspection processing or the blob inspection processing on the inspection target image acquired in step SA1, and extracts the defect candidate portion.

In step SA3, the determination unit 26 acquires the number of extracted defect candidate portions extracted in step SA2. The number of extracted defect candidate portions can be acquired from the defect candidate extraction unit 24. In step SA4, i is set to 0, and thereafter, the processing proceeds to step SA5. In step SA5, it is determined whether or not the number of extracted defect candidate portions extracted in step SA2 is larger than i. When the number of defect candidate portions extracted in step SA2 is larger than i, the processing proceeds to step SA6. In the first time, since i is set to 0 in step SA4, the number of extracted defect candidate portions extracted in step SA2 is smaller than i, the defect candidate portion is 0. In this case, the processing proceeds to step SA11, the determination that the inspection target image is the non-defective product image is confirmed.

In step SA6, the inspection through the deep learning processing having a higher discrimination ability than that of the normal inspection processing is performed on an i-th defect candidate portion. In step SA7, an inspection result through the deep learning processing is acquired. In step SA8, i=i+1 is executed, and thereafter, the processing proceeds to step SA9. In step SA9, it is determined whether or not the determination result acquired in step SA7 is the defective product. When it is determined in step SA9 that the inspection target is the defective product, the processing proceeds to step SA10, and the determination that the inspection target image is the defective product image is confirmed. Meanwhile, when NO is determined in step SA9, the processing proceeds to step SA5, and it is determined whether or not the number of extracted defect candidate portions extracted in step SA2 is larger than i. When the determination is NO, the processing proceeds to step SA11, and the determination that the inspection target image is the non-defective product image is confirmed. When “YES” is determined in step SA5, the processing proceeds to step SA6, and the aforementioned procedure is repeated. Accordingly, it is possible to perform the two-class classification of the non-defective product image class and the defective product image class.

It is possible to similarly perform two-class classification of the first defect class and the second defect class instead of the non-defective product image class and the defective product image class.

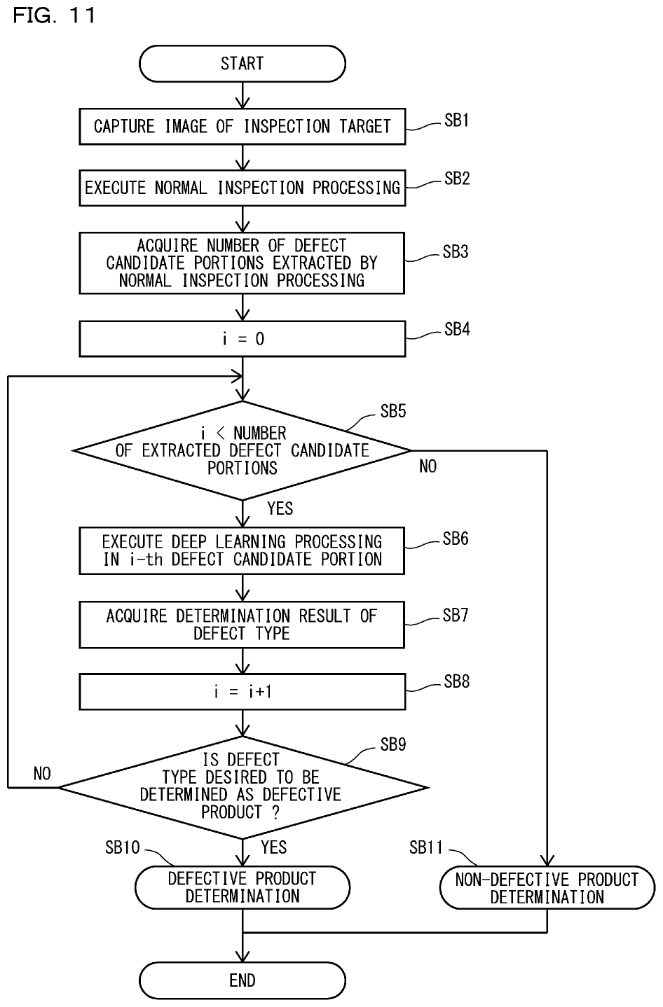

FIG. 11 is a flowchart illustrating a determination procedure when a multi-class determination is performed. In this flowchart, a classifier capable of determining the defect type is used. Before the start of the flowchart, the defect type desired to be determined by the user is set as the defective product. At the time of setting, for example, the dent 200a, the crack 200c, the chip 200d, and the foreign substance 200e can be determined to be the defective product, and the dirt 200b can be determined to be the non-defective product.

After the start of the flowchart, steps SB1 to SB6 are identical to steps SA1 to SA6 of the flowchart illustrated in FIG. 10, but not only the presence or absence of the defect but also the type of the defect is determined in the deep learning processing of step SB6.

In step SB7 of the flowchart illustrated in FIG. 11, an inspection result obtained by the deep learning processing in step SB6 is acquired. Since the type of defect is determined in step SB6, the type of the defect can be acquired in step SB7. In step SB8, i=i+1 is executed, and thereafter, the processing proceeds to step SB9. In step SB9, it is determined whether or not the defect type acquired in step SB7 is a preset defect type desired to be determined as the defective product. When YES is determined in step SB9 and the defect type acquired in step SB7 is the preset defect type desired to be determined as the defective product, the processing proceeds to step SB10, and the determination that the inspection target image is the defective product image is confirmed. Meanwhile, when NO is determined in step SB9, the processing proceeds to step SB5, and it is determined whether or not the number of extracted defect candidate portions extracted in step SB2 is larger than i. When the determination is NO, the processing proceeds to Step SB11, and the determination that the inspection target image is the non-defective product image is confirmed. When YES is determined in step SB5, the processing proceeds to step SB6, and the aforementioned procedure is repeated. That is, it is possible to determine whether or not the defect type is the defect type desired to be determined as the defective product for each of the extracted defects. When there is at least one defect type desired to be determined as the defective product, the determination that the inspection target image is the defective product at this point of time can be confirmed.

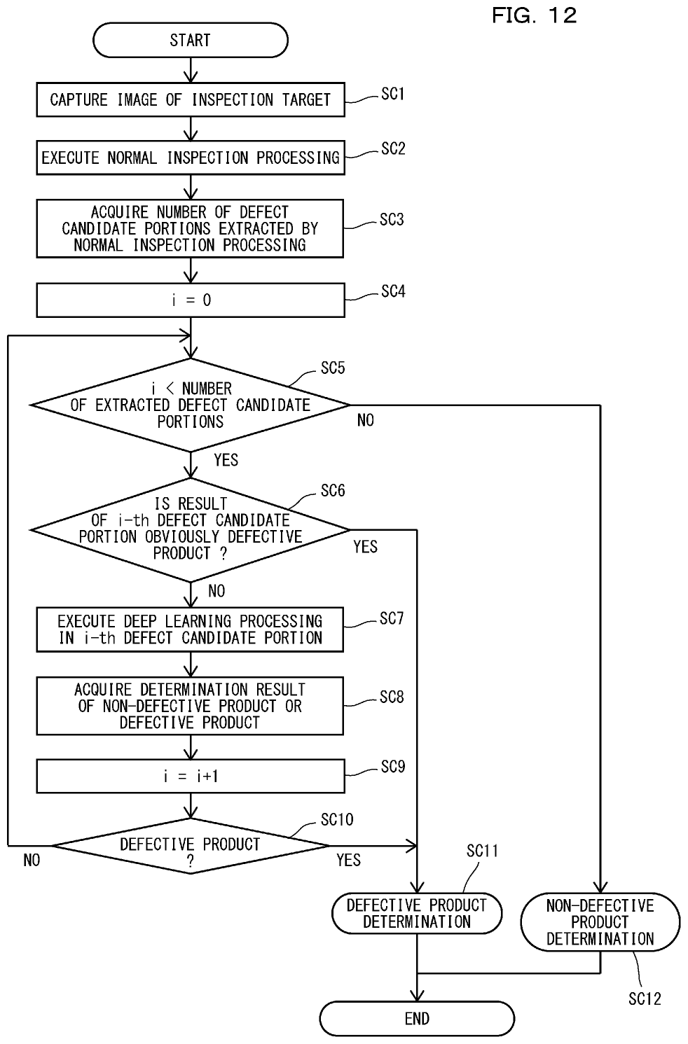

FIG. 12 is a flowchart illustrating a determination procedure when an obvious defective product is determined by the normal inspection processing and the remaining product is determined by the deep learning processing. After the start of the flowchart, steps SC1 to SC5 are identical to steps SA1 to SA5 of the flowchart illustrated in FIG. 10. In step SC6 of the flowchart illustrated in FIG. 12, it is determined whether or not the result of the i-th defect candidate portion is obviously the defective product. For example, when the defect candidate portion is extracted by the normal inspection processing, in a case where the defect candidate portion greatly exceeds a defect determination threshold, the defect candidate portion is a portion that obviously becomes the defect. Therefore, it is possible to determine whether or not the inspection target is obviously the defective product based on the defect determination threshold. It is also possible to determine whether or not the inspection target is obviously the defective product by a method other than the aforementioned method.

When YES is determined in step SC6 and the result of the i-th defect candidate portion is obviously the defective product, the processing proceeds to step SC11, and the determination that the inspection target image is the defective product image is confirmed. Meanwhile, when NO is determined in step SC6 and the result of the i-th defect candidate portion cannot be obviously determined to be the defective product, the processing proceeds to step SC7, and the inspection through the deep learning processing having a higher discrimination ability than that of the normal inspection processing is performed on the i-th defect candidate portion. In step SC8, an inspection result through the deep learning processing is acquired. In step SC9, i=i+1 is executed, and thereafter, the processing proceeds to step SC10. In step SC10, it is determined whether or not the result acquired in step SC8 is the defective product. When it is determined in step SC10 that the inspection target image is the defective product image, the processing proceeds to step SC11, and the determination that the inspection target image is the defective product image is confirmed. Meanwhile, when NO is determined in step SC10, the processing proceeds to step SC5, and it is determined whether or not the number of defect candidate portions extracted in step SC2 is larger than i. When the determination is NO, the processing proceeds to step SC12, and the determination that the inspection target image is the non-defective product image is confirmed. When YES is determined in step SC5, the processing proceeds to step SC6, and the aforementioned procedure is repeated.

(Incorporation Example into Image Inspection Apparatus 1)

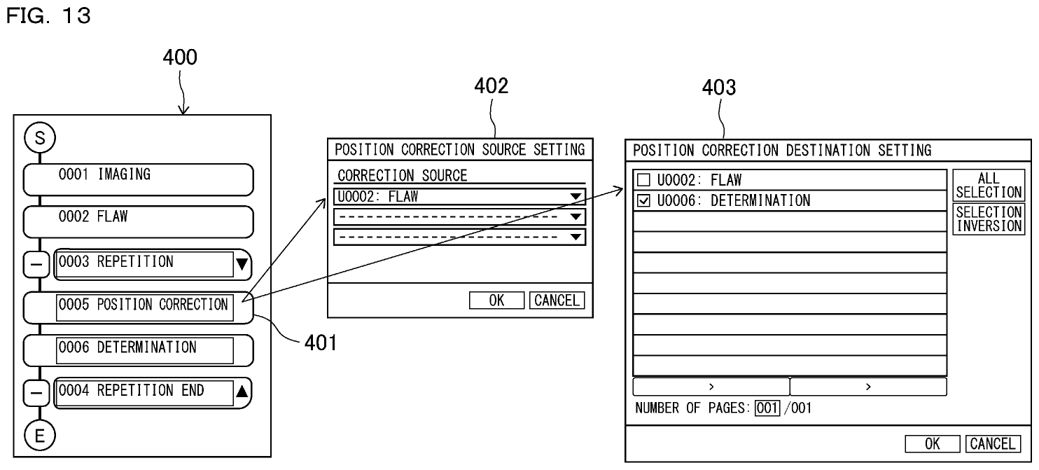

FIG. 13 is a diagram illustrating an example of a case where the normal inspection processing and the deep learning processing are incorporated into the image inspection apparatus 1. A reference sign 400 denotes a user interface illustrating an image processing procedure constructed in the general-purpose image inspection apparatus 1, and is displayed on the display device 4.

When the normal inspection processing and the deep learning processing are incorporated into the general-purpose image inspection apparatus 1, the existing image processing unit (normal inspection processing) that performs defect detection is set to a “position correction source”, and a discrimination unit using the deep learning processing is set to a “position correction destination”. In this case, first, a position correction unit 401 of a user interface 400 is selected. When the position correction unit 401 is selected, a position correction source setting user interface 402 and a position correction destination setting user interface 403 are displayed. On the position correction source setting user interface 402, a flaw detection processing unit or a blob detection processing unit can be set as the position correction source. On the position correction destination setting user interface 403, a deep learning processing unit can be set. With this setting, a processing region of the deep learning processing unit follows a position detected by the flaw detection processing unit or the blob detection processing unit.

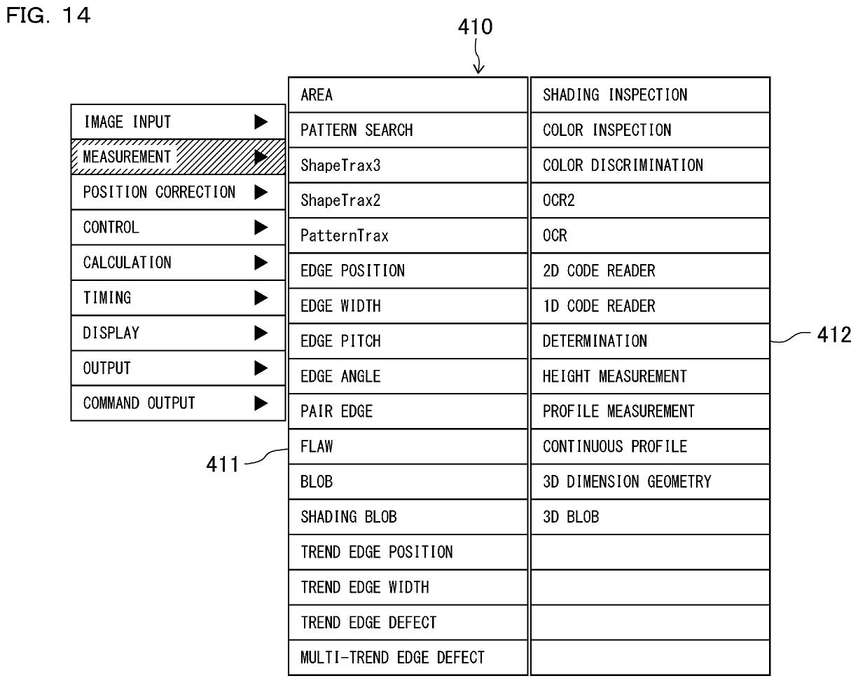

FIG. 14 illustrates a measurement unit displaying user interface 410 for displaying a list of units belonging to a category of “measurement”. In the measurement unit displaying user interface 410, a “flaw” unit 411 for extracting the defect candidate portion and a “determination” unit 412 for performing the deep learning processing can be displayed.

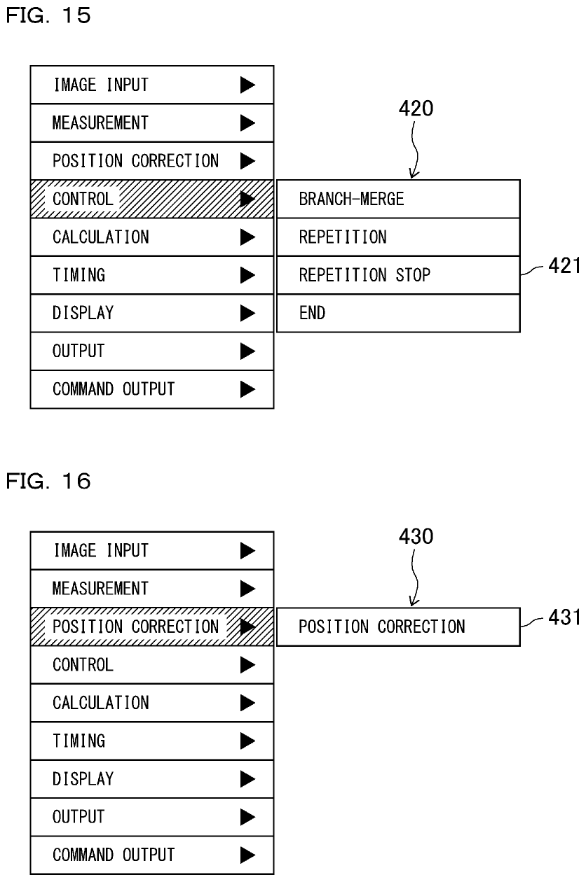

FIG. 15 illustrates a control unit displaying user interface 420 for displaying a list of a plurality of units belonging to a category of “control”. A “repetition” unit 421 belongs to the category of “control”, and a flow can be incorporated so as to run the deep learning processing by the number of defect candidate portions extracted by the “flaw” unit by performing determination processing using the deep learning processing by the number of defect candidate portions extracted by the “flaw” unit illustrated in FIG. 14.

FIG. 16 illustrates a position correction unit displaying user interface 430 that displays units belonging to the category of “position correction”. A “position correction” unit 431 can be selected from a category of “position correction”, and the deep learning processing can be performed based on the detection position of the existing image processing by setting the “discrimination” unit that uses the deep learning processing for the position correction destination as described above.

### Advantageous Effects of Embodiment

As described above, in accordance with the image inspection apparatus 1 according to the present embodiment, a classifier that classifies the inspection target images into a plurality of classes can be generated by inputting the plurality of images including the inspection target to the input layer of the neural network in the setting mode in which various settings are performed. In the running mode of the image inspection apparatus 1, when the inspection target image acquired by capturing the inspection target is input to the defect candidate extraction unit 24, the defect candidate portion is extracted based on the pixel value of the inspection target image. When the defect candidate portion is extracted, for example, the portion at which the predetermined difference or more from the surroundings is generated may be set as the defect candidate portion based on the segmented average density value, or the portion at which the density value is equal to or smaller than the predetermined value, is equal to or larger than the predetermined value, is within the predetermined range, or is out of the predetermined range may be set as the defect candidate portion by binarization based on the density value. Since these methods are all the general normal inspection processing, the high-speed processing can be performed.

When the defect candidate portion is extracted, since the inspection window is set in the region including the defect candidate portion and the image within the inspection window is input to the classifier, the deep learning processing is performed only on a part of the inspection target image. Therefore, the rapidity of the inspection processing is ensured. Since the class to which the inspection target image is classified is determined based on the output result of the classifier, it is possible to cope with a complicated determination.

Therefore, it is possible to extract the candidate portions at which the defect may be present at a high speed by the normal inspection processing, and it is possible to increase an ability to cope with the complicated determination by applying the deep learning processing having a high processing load to only the extracted candidate portions.

The aforementioned embodiment is merely an example in all respects, and should not be interpreted in a limited manner. All modifications and changes belonging to the equivalent scope of the claims are within the scope of the present invention.

As described above, the image inspection apparatus according to the present invention can be used when the quality determination of an inspection target is performed based on an inspection target image obtained by capturing the inspection target.

What is claimed is:

1. An image inspection apparatus that inspects inspection targets based on inspection target images acquired by capturing the inspection targets, the apparatus comprising:
a classifier generation section that generates a classifier which classifies the inspection target images into a first class and a second class by inputting a plurality of learning images including the inspection target image into an input layer of a neural network and causing the neural network to learn in a setting mode;
an image input section that inputs the inspection target image in a running mode;
a defect candidate extraction section that extracts a defect candidate portion which becomes a defect based on a pixel value of the inspection target image input by the image input section;
an inspection window setting section that sets an inspection window in a region including the extracted defect candidate portion; and
a determination section that determines whether the inspection target image is classified into the first class or the second class by inputting an image within the inspection window set by the inspection window setting section to the classifier generated by the classifier generation section.

2. The image inspection apparatus according to claim 1, wherein
the first class is a non-defective product image class into which a non-defective product image is classified,
the second class is a defective product image class into which a defective product image is classified, and
the classifier generation section is configured to generate a classifier which classifies the inspection target images into the non-defective product image class and the defective product image class by inputting, as the learning image, a plurality of non-defective product images to which non-defective product attributes are given and/or a plurality of defective product images to which defective product attributes are given to the input layer of the neural network and causing the neural network to learn in the setting mode.

3. The image inspection apparatus according to claim 1, wherein
the first class is a first defect class into which an image including a first defect is classified,
the second class is a second defect class into which an image including a second defect is classified, and
the classifier generation section is configured to generate a classifier which classifies the inspection target images into the first defect class and the second defect class by inputting, as the learning image, a plurality of images including the first defect and a plurality of images including the second defect to the input layer of the neural network and causing the neural network to learn in the setting mode.

4. The image inspection apparatus according to claim 3, wherein
the first defect includes a plurality of types of defects.

5. The image inspection apparatus according to claim 1, wherein
the classifier generation section is configured to input, as the learning image, a plurality of images including a defect into the input layer of the neural network and cause the neural network to learn in the setting mode.

6. The image inspection apparatus according to claim 5, wherein
the classifier generation section is configured to input a region of the learning image including the defect to the input layer of the neural network and cause the neural network to learn in the setting mode.

7. The image inspection apparatus according to claim 1, wherein
the classifier generation section is configured to perform normalization processing on an image size to be input to the input layer of the neural network in the setting mode.

8. The image inspection apparatus according to claim 7, wherein
the classifier generation section sets an enlargement ratio at the time of performing the normalization processing to be equal to or smaller than a predetermined value.

9. The image inspection apparatus according to claim 1, wherein
the defect candidate extraction section is configured to perform flaw detection processing for extracting, as a defect candidate portion, a portion at which a predetermined difference or more from surroundings is generated based on a segmented average density value.

10. The image inspection apparatus according to claim 1, wherein
the defect candidate extraction section is configured to perform blob detection processing for extracting, as a defect candidate portion, a portion at which a density value is equal to or smaller than a predetermined value, is equal to or larger than the predetermined value, is within a predetermined range, or is out of the predetermined range by binarization based on the density value.
